(19) United States
(12) Patent Application Publication
(10) Pub. No.: US 2013/0024227 A1
(43) Pub. Date: Jan. 24, 2013

(54) INFORMATION PROCESSING TECHNIQUE FOR DETERMINING TRAVELING ROUTE

(71) Applicants: Hidenao IWANE, Kawasaki (JP); Akifumi Kira, Tokyo (JP)

(72) Inventors: Hidenao IWANE, Kawasaki (JP); Akifumi Kira, Tokyo (JP)

(73) Assignee: FUJITSU LIMITED, Kawasaki-shi (JP)

(21) Appl. No.: 13/527,824

(22) Filed: Jun. 20, 2012

(30) Foreign Application Priority Data
Jul. 20, 2011 (JP) 2011-158552

(51) Int. Cl. G06Q 10/04

(52) U.S. Cl. 705/7.13

(57) ABSTRACT

A disclosed method includes determining, for each operator group, scheduled execution order by arranging, for each operator group, the predetermined number of operations to be conducted while traveling, wherein at least a portion of the predetermined number of operations is allotted to each of the operator groups; determining, for each operator group, operations to be conducted in the scheduled execution order by determining, for each operator group, along the scheduled execution order of the operator group and while advancing time, whether movement to an operation place of each operation of the predetermined number of operations and start of the operation satisfy a constraint condition set in advance for the predetermined number of operations; and calculating a first evaluation value of orders of the operations determined to be conducted for the plural operator groups.

### CROSS-REFERENCE TO RELATED APPLICATIONS

This application is based upon and claims the benefit of priority of the prior Japanese Patent Application No. 2011-158552, filed on Jul. 20, 2011, the entire contents of which are incorporated herein by reference.

### FIELD

This technique relates to a technique for determining a traveling route according to constraint conditions.

### BACKGROUND

The traveling salesman problem is a problem that n cities (also called “operation point” or “operation place”) and distances between respective cities are input and a route having the minimal total movement distance is selected from among routes that the salesman returns to the original city after visiting the respective cities once. This problem is known as the NP hard problem, and is a typical difficult combinatorial optimization problem. However, because this problem can be applied to a lot of fields such as delivery planning, drilling of the board, rolling planning of steel plates and the like, it is preferable that such problems are processed by any means in a short time.

Extension of the traveling salesman problem includes a traveling salesman problem with constraint conditions. This traveling salesman problem with the constraint conditions includes a problem that plural groups (also called “teams”) conduct operations, and this problem includes a problem that an operation time of the last group that returned to the original place is minimized and a problem that the total sum of the operation times of all of the groups is minimized. According to the former, the entire operation time is minimized. According to the latter, the total movement distance is minimized, and it is possible to reduce the movement cost such as gasoline cost and the like. The constraint conditions include a priority condition that is a constraint for the order of the traveling operation places, a constraint (rendezvous condition or rendezvous-allowing condition) for conducting operations by the plural rendezvousing groups and the like. Incidentally, the rendezvous condition is set, for example, when the operation should be conducted by the plural rendezvousing groups. The rendezvous-allowing condition is set when the operational efficiency is improved by conducting the operation together. Problems that can be formulated to the traveling salesman problem with constraint conditions include personnel assignment problem, logistics problem, delivery planning, planning problem of the restoration from the disaster and the like.

There are various algorithms for solving the traveling salesman problem, and one of them is a local search method for improving the solution by searching the vicinity of the traveling route that is defined by any method. However, there is a case where the conventional local search method itself cannot be applied depending on the constraint conditions being set.

For example, a local search method, which is called “two-point exchange algorithm” is known. In this method, in case where a traveling route (1, 5, 6, 7, 2, 4, 3) is determined by any means as illustrated in FIG. 1A, two arbitrary points such as operation points 2 and 5 are exchanged. Namely, a new traveling route (1, 2, 6, 7, 5, 4, 3) is obtained. At this time, when the length of the traveling route becomes shorter, the changed traveling route (1, 2, 6, 7, 5, 4, 3) is adopted, on the other hand, when the length of the traveling route does not become shorter, the traveling route (1, 5, 6, 7, 2, 4, 3) before the change is adopted. Such a processing is repeated until the reduction of the length of the traveling route becomes impossible.

However, the two-point exchange algorithm cannot be simply applied to the traveling salesman problem with the priority condition, in which two groups conducts operations. For example, it is assumed that the priority condition as illustrated in FIG. 2 is defined. Namely, after the operation 1 at the operation point 1 is conducted, the operations 2 and 3 are conducted at the operation points 2 and 3, and after the operation 5 is conducted at the operation point 5, the operation 6 is conducted at the operation point 6, and after the operation 9 is conducted at the operation point 9, the operation 10 is conducted at the operation point 10. Furthermore, an order of the operations is determined by any method as follows: The group A conducts the operation 1 at the operation point 1, operation 2 at the operation point 2, operation 3 at the operation point 3, operation 4 at the operation point 4, operation 10 at the operation point 10, and operation 7 at the operation point 7 in this order. The group B conducts the operation 5 at the operation point 5, operation 9 at the operation point 9, operation 8 at the operation point 8, and operation 6 at the operation point 6 in this order.

FIG. 3 schematically illustrates an operation execution status in such a case. Incidentally, in FIG. 3, the operation time for each of the operations at each of the operation points is represented by the horizontal length of the box, and the movement time is represented by the length of a horizontal arrow. Because the group A conducts the operations 1 to 3 in this order, the priority condition is satisfied. In addition, the group B conducts the operations 5 and 6 between which the operations 9 and 8 are sandwiched so as to satisfy the priority condition. Furthermore, the schedule that the group B precedently conducts the operation 9 and the group A conducts the operation 10 later is made so as to satisfy the priority condition illustrated in FIG. 2.

In such a status, while paying attention only to the group B, for example, it is assumed that the two-point exchange algorithm to exchange the operation 9 with the operation 6 is executed. Then, an operation execution status as illustrated in FIG. 4 is obtained. As illustrated in FIG. 4, the operation execution status of the group A does not change from that illustrated in FIG. 3. Moreover, when paying attention only to the group B, the priority condition that the operation 6 is conducted after conducting the operation 5 is satisfied, even when the aforementioned exchange of the operation order is carried out. However, because the operation 9 is postponed, the operation 10 that the group A conducts is conducted before the operation 9 that the group B conducts. Therefore, the priority condition is not satisfied. Thus, in order to entirely satisfy the priority condition, the second improvement is required. However, this second improvement may further cause a new portion at which the priority condition is not satisfied.

A two-point exchange algorithm is a mere example of the local search methods, and other local search methods (e.g. 2-opt (k-opt) method, or-opt method, k-point exchange method, genetic algorithms, Simulated Annealing method, Tabu search method or the like) have similar problems.

In addition, there is a technique for acquiring a solution, in which the number of vehicles is reduced, of the delivery route problem using plural vehicles. Specifically, a method for generating a delivery plan to deliver goods to plural points from a certain base point by plural vehicles includes repeating the local search to update S until a solution set (N(S)) including vicinity solutions of the present given solution S satisfies a given end condition, to obtain the best solution Sbest. The local search includes searching for a solution that the number of vehicles is minimal, and when there are plural solutions that the number of vehicles is minimal, searching the plural solutions for a solution that an indicator β(t) is minimal that is defined by the following expression (2) and represents how little the variation of evaluation values Bk(t)(t∈N(S)) of the respective vehicles, which are defined by the following expression (1), is.

Bk(t)=Σi∈Ck(t)pi/M (1)

β(t)=1−Σk∈σ(t)Bk(t)m/|σ(t)| (2)

However, this technique cannot handle the aforementioned problem that the local search cannot be simply applied.

Namely, there is no technique for enabling to apply the typical local search method to a problem that an operation order is determined when plural operations to be conducted while traveling are shared at least partially with plural operator groups.

### SUMMARY

An information processing method relating to this embodiment includes: determining, for each of a plural operator groups, scheduled execution order by arranging, for each of the plural operator groups, the predetermined number of operations to be conducted while traveling, wherein at least a portion of the predetermined number of operations is allotted to each of the plural operator groups; determining, for each of the plural operator groups, operations to be conducted in the scheduled execution order by determining, for each of the plural operator groups, along the scheduled execution order of the operator group and while advancing time, whether movement to an operation place of each operation of the predetermined number of operations and start of the operation satisfy a constraint condition set in advance for the predetermined number of operations; and calculating an evaluation value of orders of the operations determined to be conducted for the plural operator groups.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1A is a diagram to explain a two-point exchange algorithm;

FIG. 1B is a diagram to explain the two-point exchange algorithm;

FIG. 2 is a diagram illustrating an example of a priority condition;

FIG. 3 is a diagram illustrating an example of an operation execution status;

FIG. 4 is a diagram illustrating the operation execution status after changing by the two-point exchange algorithm;

FIG. 5 is a functional block diagram of an information processing apparatus relating to a first embodiment;

FIG. 6 is a diagram depicting a processing flow of a processing relating to the first embodiment;

FIG. 7 is a diagram depicting an example of a scheduled execution order;

FIG. 8A is a diagram schematically depicting a processing of a traveling processing unit;

FIG. 8B is a diagram schematically depicting a processing of the traveling processing unit;

FIG. 8C is a diagram schematically depicting a processing of the traveling processing unit;

FIG. 8D is a diagram schematically depicting a processing of the traveling processing unit;

FIG. 8E is a diagram schematically depicting a processing of the traveling processing unit;

FIG. 8F is a diagram schematically depicting a processing of the traveling processing unit;

FIG. 8G is a diagram schematically depicting a processing of the traveling processing unit;

FIG. 8H is a diagram schematically depicting a processing of the traveling processing unit;

FIG. 9A is a diagram representing data of an execution order stored in a storage unit;

FIG. 9B is a diagram representing data of the execution order stored in the storage unit;

FIG. 9C is a diagram representing data of the execution order stored in the storage unit;

FIG. 9D is a diagram representing data of the execution order stored in the storage unit;

FIG. 9E is a diagram representing data of the execution order stored in the storage unit;

FIG. 9F is a diagram representing data of the execution order stored in the storage unit;

FIG. 9G is a diagram representing data of the execution order stored in the storage unit;

FIG. 9H is a diagram representing data of the execution order stored in the storage unit;

FIG. 10 is a diagram to explain operations determined to be conducted;

FIG. 11 is a diagram depicting an example of the scheduled execution order after the change;

FIG. 12 is a diagram to explain the operations determined in the scheduled execution order after the change;

FIG. 13 is a diagram schematically depicting an execution status after the change;

FIG. 14 is a functional block diagram of an information processing apparatus relating to a second embodiment;

FIG. 15 is a diagram depicting an example of a movement cost table;

FIG. 16 is a diagram depicting an example of a constraint condition table;

FIG. 17 is a diagram depicting an example of a processing capability table;

FIG. 18A is a diagram depicting an example of a group management table;

FIG. 18B is a diagram depicting an example of a present operation amount management table;

FIG. 19 is a diagram depicting an example of a traveling route management table;

FIG. 20 is a diagram depicting a processing flow in the second embodiment;

FIG. 21A is a diagram to explain an initial setting processing;

FIG. 21B is a diagram to explain the initial setting processing;

FIG. 21C is a diagram to explain the initial setting processing;

FIG. 22 is a diagram depicting a processing flow of a traveling time calculation processing;

FIG. 23 is a diagram depicting an initial state in the group management table;

FIG. 24 is a diagram depicting an initial state in the traveling route management table;

FIG. 25 is a diagram depicting a processing flow of a stage processing;

FIG. 26 is a diagram depicting a processing flow of the stage processing;

FIG. 27 is a diagram depicting a processing flow of the stage processing;

FIG. 28 is a diagram depicting a processing flow of an adjustment processing;

FIG. 29 is a diagram depicting a processing flow of a time advancing processing;

FIG. 30 is a diagram to explain another setting method of the scheduled traveling route;

FIG. 31A is a diagram depicting a state of the traveling route management table, when the traveling time calculation processing is completed;

FIG. 31B is a diagram depicting a state of the traveling route management table after update;

FIG. 32 is a diagram depicting an example of the two-point algorithm;

FIG. 33A is a diagram to explain the two-point exchange algorithm;

FIG. 33B is a diagram to explain the two-point exchange algorithm; and

FIG. 34 is a functional block diagram of a computer.

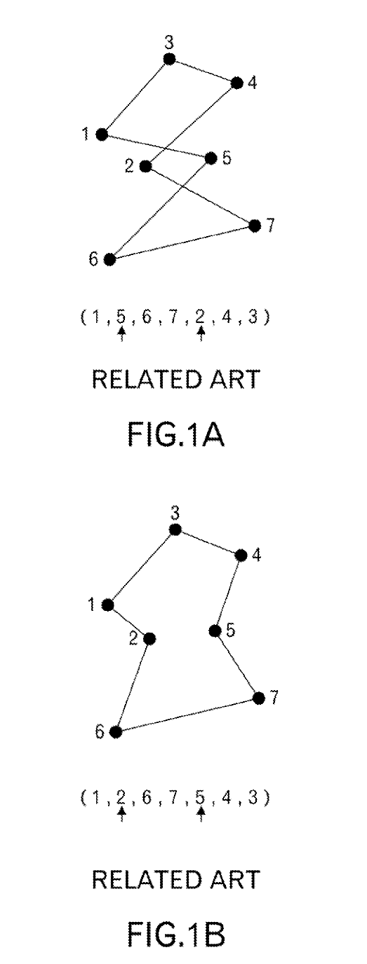

### DESCRIPTION OF EMBODIMENTS

### Embodiment 1

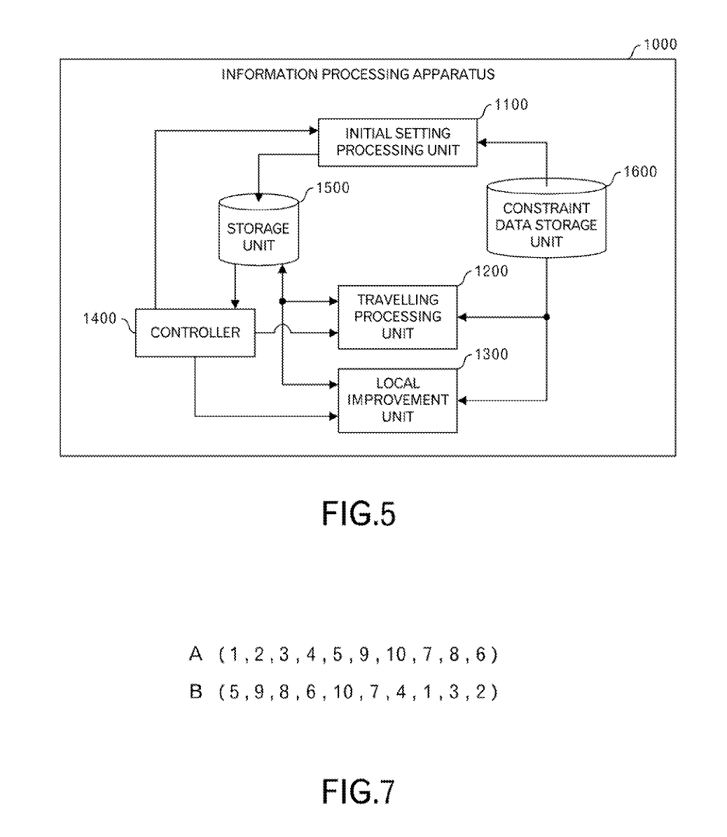

FIG. 5 illustrates a functional block diagram of an information processing apparatus 1000 relating to a first embodiment of this technique. The information processing apparatus 1000 has an initial setting processing unit 1100, traveling processing unit 1200, local improvement unit 1300, controller 1400, storage unit 1500 and constraint data storage unit 1600.

The constraint data storage unit 1600 stores data for constraint conditions that have been set for plural operations to be conducted while traveling. The constraint conditions may include the priority condition, rendezvous condition and/or rendezvous-allowing condition. In addition, the constraint data storage unit 1600 also stores data for movement costs (time or distance) between operation places, operation amounts for the respective operations and operation processing capabilities for the respective operator groups.

The controller 1400 controls the initial setting processing unit 1100, traveling processing unit 1200 and local improvement unit 1300 to carry out a processing, which will be explained later.

The initial setting processing unit 1100 arranges plural operations to be conducted, while traveling, by these plural operator groups for each of the operator groups so as to satisfy the priority condition if the priority condition is stored in the constraint data storage unit 1600, to generate scheduled execution orders, and stores data of the scheduled execution orders into the storage unit 1500.

While advancing the time, the traveling processing unit 1200 determines, for each of the operator groups and along the scheduled execution order, whether or not the movement to the operation place and start of the operation satisfy the constraint conditions stored in the constraint data storage unit 1600, determines the operations to be conducted in the scheduled execution order for each operator group, and stores data of the operations to be conducted for each operator group into the storage unit 1500. In addition, the traveling processing unit 1200 calculates an evaluation value for the determined operation order (i.e. operation allotment), and stores the calculated evaluation value into the storage unit 1500. The evaluation value may be the total sum of the operation times and movement times for the respective operator groups or the greatest value of the total sums, each of which is calculated by adding the operation time and movement time of the operator group. Incidentally, the traveling processing unit 1200 calculates the time consumed for each operation and the time consumed for the movement between the operation places, by using data stored in the constraint data storage unit 1600, when advancing the time.

The local improvement unit 1300 changes the scheduled execution orders stored in the storage unit 1500 so as to satisfy the priority condition when the priority condition is stored in the constraint data storage unit 1600, and stores data of the scheduled execution orders after the change into the data storage unit 1500. The processing of this local improvement unit 1300 is carried out according to the algorithm of the conventional local search method.

The controller 1400 causes the traveling processing unit 1200 to carry out a processing for the scheduled execution orders after the change, and to calculate the evaluation value for the scheduled execution order after the change. Then, the controller 1400 determines whether or not the evaluation value calculated for the scheduled execution order after the change is lowered compared with the previously calculated evaluation value, and when the evaluation value is lowered, the controller 1400 stores the calculated evaluation value, data of the operation order and the scheduled execution orders after the change as data for the next processing into the storage unit 1500. When the evaluation value calculated for the scheduled execution orders after the change is not lowered, the controller 1400 discards the scheduled execution orders after the change and associated data. Then, the controller 1400 causes the local improvement unit 1300 and traveling processing unit 1200 to carry out the processing until the end condition is satisfied.

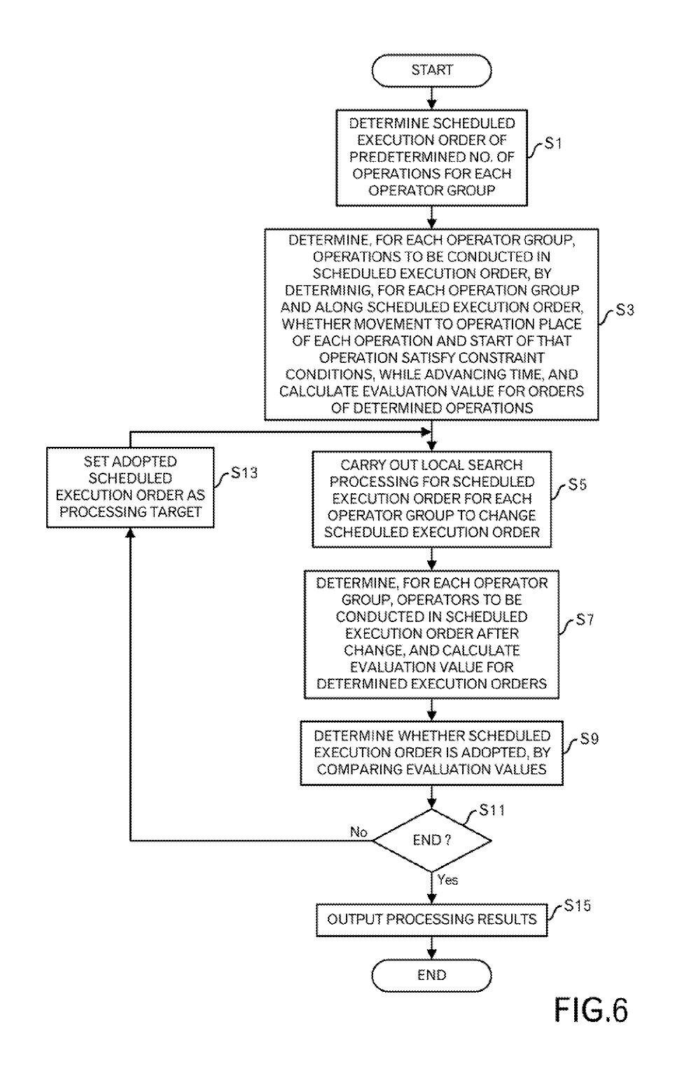

Next, processing contents of the information processing apparatus 1000 will be explained by using FIGS. 6 to 13. As an assumption, the constraint data storage unit 1600 stores data such as the number of operator groups, constraint conditions, movement costs between operation places (including start point and goal point), operation amounts of the respective operations, operation processing capabilities of the respective operator groups, and the like. In addition, it is assumed that the start point and goal point are different from the operation places. However, the start point may be the same as the goal point.

The controller 1400 causes the initial setting processing unit 1100 to determine, for each operator group, a scheduled execution order for the predetermined number of operations to be conducted, while traveling, by all of the operator groups, and to store data of the scheduled execution orders into the storage unit 1500 (FIG. 6: step S1). At this time, the initial setting processing unit 1100 determines the arrangement of the operations in the scheduled execution orders of the respective operator groups so as to satisfy the priority order when the priority condition is stored in the constraint data storage unit 1600. For example, the operations are arranged randomly, and then, the rearrangement is carried out for portions in which the priority condition is not satisfied.

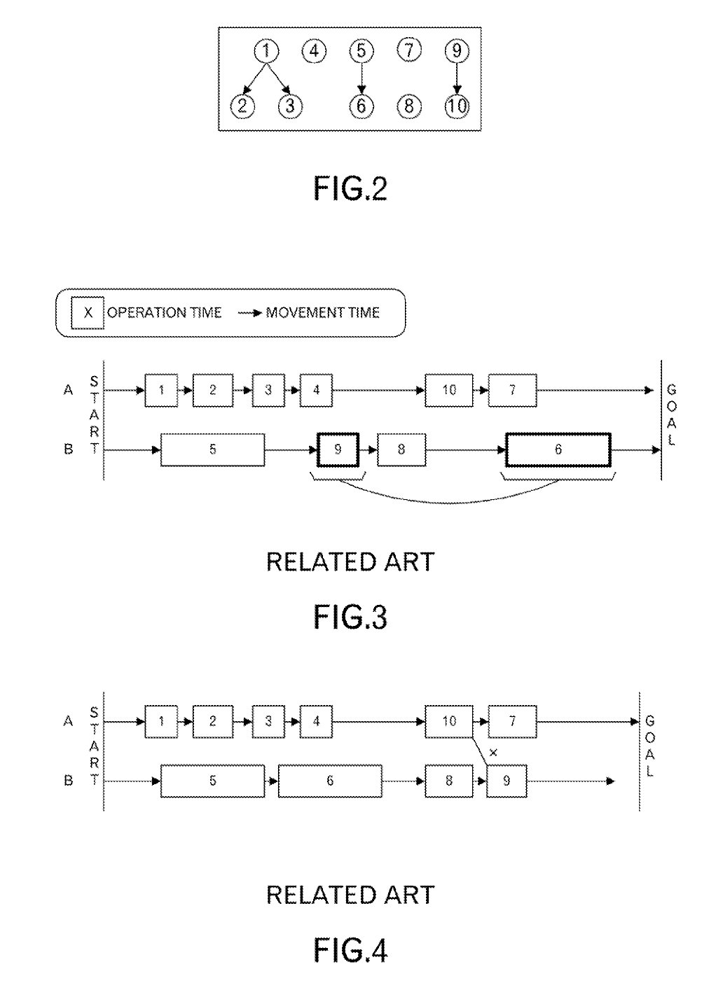

For example, it is assumed that there are two operator groups, the priority condition as illustrated in FIG. 2 is set, the two operator groups begin the movement from a certain start point, the two operator groups conduct the operations 1 to 10 at the operation points 1 to 10, and the two operator groups return to an end point after the completion of the operations. Then, it is assumed that the scheduled execution orders as illustrated in FIG. 7 are determined. For the operator groups A and B, the scheduled execution orders respectively including the operations 1 to 10 at the operation points 1 to 10 are determined. These scheduled execution orders respectively satisfy the priority condition within themselves. However, at this stage, what operations are conducted is not fixed. In addition, in this embodiment, it is assumed that one operation is associated with one operation place (i.e. operation point).

Next, the controller 1400 causes the traveling processing unit 1200 to carry out a following processing (step S3). In other words, the traveling processing unit 1200 determines, for each operator group, the operations to be conducted in the scheduled execution order, by determining, for each operator group and along the scheduled execution order, whether or not the movement to the operation place of each operation and start of that operation satisfy the constraint conditions, which include the priority condition and the like and are stored in the constraint data storage unit 1600, while advancing the time, and stores data of the operations to be conducted into the storage unit 1500. Furthermore, the traveling processing unit 1200 calculates an evaluation value for the determined operation order, and stores data of the evaluation value into the storage unit 1500. For example, the evaluation value is the greatest value of the total sums, each of which is obtained by adding the operation time and the movement time, or the total sum of the movement times and operation times for the respective operator groups. Moreover, the operation that has been completed by another operator group is not conducted again and is skipped.

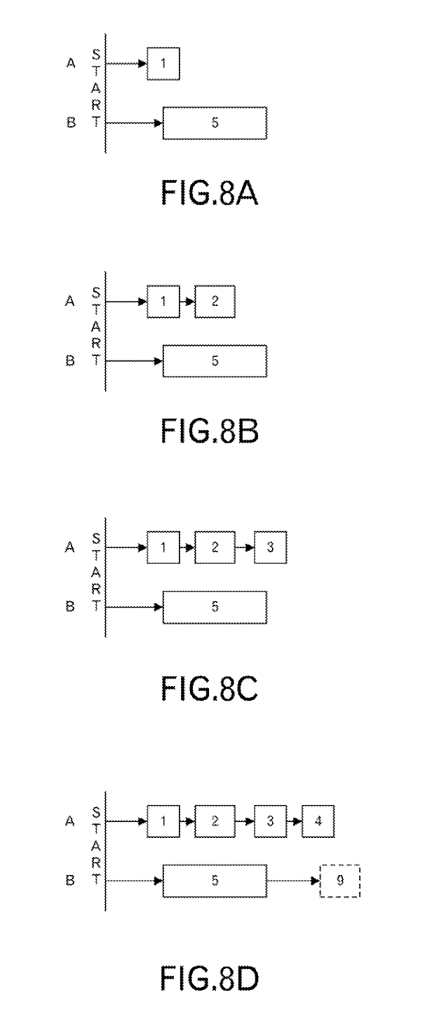

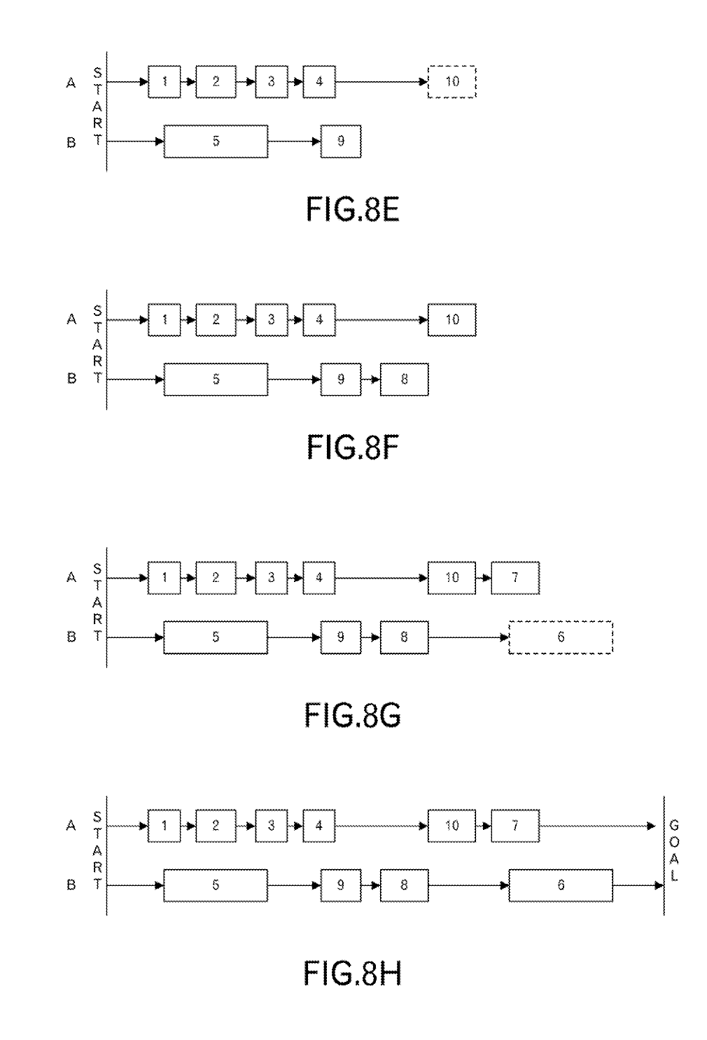

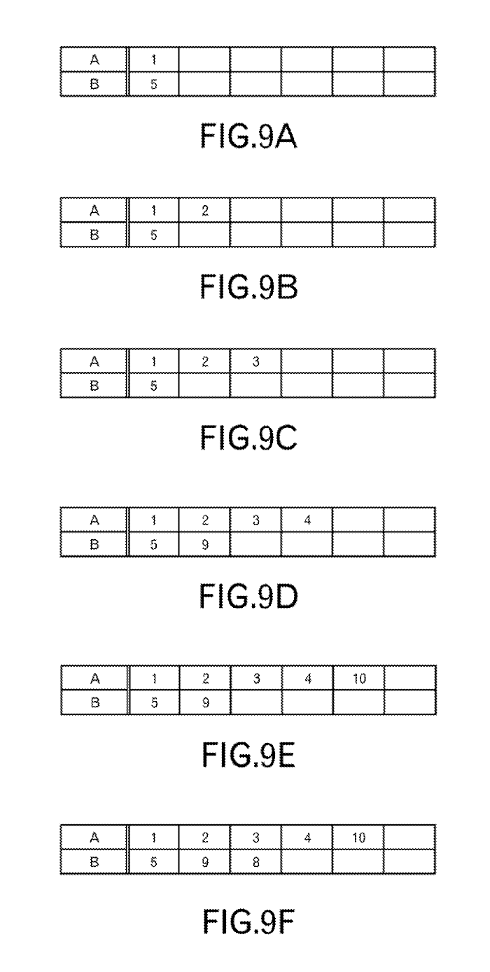

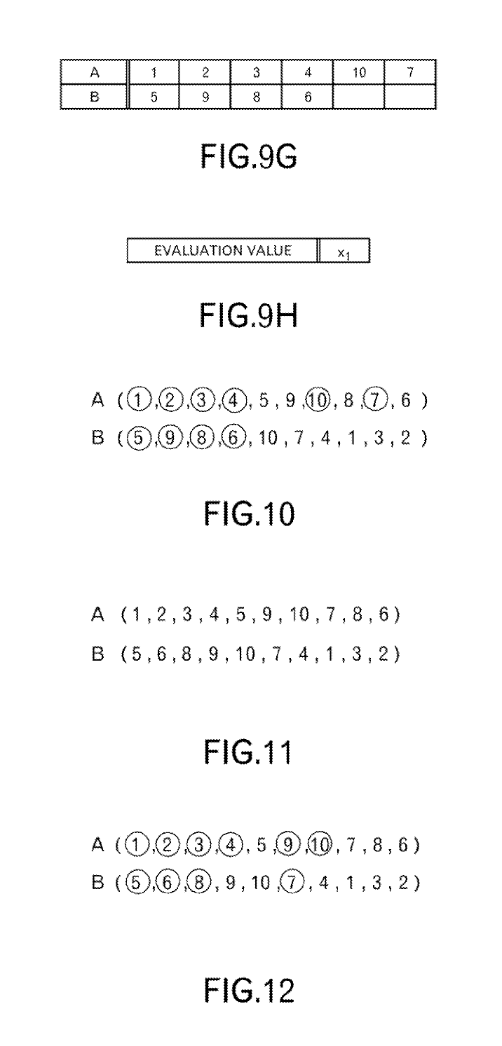

More specifically, the movement time is identified from a movement cost between the operation places. Furthermore, the operation time is calculated by dividing an amount of operation by the processing capability. The time proceeds with such data. Then, when the constraint conditions are satisfied with conducting the operation 1 by the operator group A, the operator group A moves to the operation place (i.e. operation place 1) of the operation 1. Furthermore, when the constraint conditions are satisfied with conducting the operation 5 by the operator group B, the operator group B moves to the operation place (i.e. operation place 5) of the operation 5. Then, in case where the constraint conditions such as the rendezvous condition when starting the operation 1 are satisfied, the operator group A begins the operation 1. Moreover, in case where the constraint conditions such as the rendezvous condition when starting the operation 5 are satisfied, the operator group B begins the operation 5. Namely, a state as illustrated in FIG. 8A is obtained. Incidentally, in FIGS. 8A to 8H, the length of the arrow represents the movement time, and the length of the rectangle represents the operation time, similarly to FIG. 3. The storage unit 1500 stores, for each operator group, the movement destination or operation being executed. Namely, data as illustrated in FIG. 9A is stored in the storage unit 1500.

Furthermore, when the operation 1 is completed, and when the constraint conditions are satisfied with conducting the next operation 2 in the scheduled execution order by the operator group A, the operator group A moves to the place of the operation 2. Moreover, in case where the constraint conditions such as the rendezvous condition when starting the operation 2 are satisfied, the operator group A begins the operation 2. In this period, the operator group B is conducting the operation 5. Then, a state as illustrated in FIG. 8B is obtained. Moreover, data as illustrated in FIG. 9B is stored in the storage unit 1500.

Furthermore, when the operation 2 is completed, and when the constraint conditions are satisfied with conducting the next operation 3 in the scheduled execution order by the operator group A, the operator group A moves to the place of the operation 3. Moreover, in case where the constraint conditions such as the rendezvous condition when starting the operation 3 are satisfied, the operator group A begins the operation 3. In this period, the operator group B is still conducting the operation 5. Then, a state as illustrated in FIG. 8C is obtained. Moreover, data as illustrated in FIG. 9C is stored in the storage unit 1500.

After that, while the operator group A is conducting the operation 3, the operator group B completes the operation 5. Then, when the constraint conditions are satisfied with conducting the next operation 9 in the scheduled execution order by the operator group B, the operator group B moves to the place of the operation 9. Furthermore, when the operation 3 is completed, and when the constraint conditions are satisfied with conducting the next operation 4 in the scheduled execution order by the operator group A, the operator group A moves to the place of the operation 4. Moreover, in case where the constraint conditions such as the rendezvous condition when starting the operation 4 are satisfied, the operator group A begins the operation 4. Then, a state as illustrated in FIG. 8D is obtained. In addition, data as illustrated in FIG. 9D is stored in the storage unit 1500.

After that, in case where the constraint conditions such as the rendezvous condition when starting the operation 9 are satisfied, the operator group B begins the operation 9. Furthermore, when the operation 4 is completed, it is determined whether or not the constraint conditions are satisfied with conducting the next operation 5 in the scheduled execution order by the operator group A. In this case, the operator group B has completed the operation 5. Therefore, the operator group A does not move to the place (i.e. operation place 5) of the operation 5. Furthermore, it is determined whether or not the constraint conditions are satisfied with conducting the further next operation 9 in the scheduled execution order by the operator group A. In this case, it has been settled that the operator group B would conduct the operation 9, and when there is a rendezvous condition that there is no need to rendezvous the place of the operation 9 and the operator group that precedently moves to the place of the operation 9 has a priority, it is determined that this rendezvous condition is not satisfied. Therefore, the operator group A does not move to the place (i.e. operation place 9) of the operation 9. Furthermore, it is determined whether or not the constraint conditions are satisfied with conducting the further next operation 10 in the scheduled execution order by the operator group A. Because a priority condition that the operation 9 should be conducted prior to the operation 10 has been set, data in the storage unit 1500 (FIG. 9D) is checked. In such a case, there is no problem because the operation 9 has been completed. Therefore, the operator group A moves to the place (i.e. operation place 10) of the operation 10. Then, a state as illustrated in FIG. 8E is obtained. In addition, data as illustrated in FIG. 9E is stored in the storage unit 1500.

After that, when the operation 9 is completed, and when the constraint conditions are satisfied with conducting the next operation 8 in the scheduled execution order by the operator group B, the operator group B moves to the place of the operation 8. Furthermore, in case where the constraint conditions such as the rendezvous condition when starting the operation 8 are satisfied, the operator group B begins the operation 8. On the other hand, in case where the constraint conditions such as the rendezvous condition when starting the operation 10 are satisfied, the operator group A begins the operation 10. Then, a state as illustrated in FIG. 8F is obtained. In addition, data as illustrated in FIG. 9F is stored in the storage unit 1500.

After that, when the operation 8 is completed, and when the constraint conditions are satisfied with conducting the next operation 6 in the scheduled execution order by the operator group B, the operator group B moves to the place of the operation 6. Furthermore, when the operation 10 is completed, and when the constraint conditions are satisfied with conducting the next operation 7 in the scheduled execution order by the operator group A, the operator group A moves to the place of the operation 7. Then, in case where the constraint conditions such as the rendezvous condition when starting the operation 7 are satisfied, the operator group A begins the operation 7. Then, a state as illustrated in FIG. 8G is obtained. In addition, data as illustrated in FIG. 9G is stored in the storage unit 1500.

After that, when the operation 6 is completed, it is determined whether or not the constraint conditions are satisfied with conducting the subsequent operations 10, 7, 4, 1, 3 and 2 in the scheduled execution order by the operator group B. Here, these operations have been completed by the operator group A. Therefore, the operator group B moves to the goal point without moving to the places of these operations.

Similarly, when the operation 7 is completed, it is determined whether or not the constraint conditions are satisfied with conducting the subsequent operations 8 and 6 in the scheduled execution order by the operator group A. Here, these operations have been completed by the operator group B. Therefore, the operator group A moves to the goal point without moving to the places of these operations. Then, a state as illustrated in FIG. 8H is obtained. Incidentally, although the arrow of the operator group A does not reach the goal point, it is simply represented that the operator group A reached the goal point with shorter time than that of the operator group B.

Thus, while advancing the time, it is determined step-by-step whether or not it is possible to move to the next operation place, and whether or not it is possible to start the next operation when arriving at the next operation place and the like, and data concerning the operations with which the constraint conditions are satisfied is stored in the storage unit 1500 for each operator group. Then, data concerning the allotment of the operations is stored in the storage unit 1500. Incidentally, as illustrated in FIG. 10, the operations of the numbers with the circles among the operations included in the scheduled execution order illustrated in FIG. 7 are identified as the operations to be conducted. In addition, the operations of the numbers with the circles are conducted from the left side to the right side. As also understood from FIG. 10, there are operations that are not carried out although they are included in the scheduled execution order, and there is a case where the operations are sporadically carried out.

Furthermore, the traveling processing unit 1200 calculates an evaluation value by calculating the total sum of the movement times and the operation times of the operator groups A and B, for example, or calculates an evaluation value by identifying the greatest value of the total sum of the movement time and operation time of the operator group A and the total sum of the movement time and operation time of the operator group B, and stores the evaluation value into the storage unit 1500. For example, the evaluation value as illustrated in FIG. 9H is stored in the storage unit 1500.

Returning to the explanation of the processing illustrated in FIG. 6, the controller 1400 causes the local improvement unit 1300 to change the scheduled execution order by causing to carry out a processing for the scheduled execution orders of the respective operator groups, which are stored in the storage unit 1500, according to the local search method (step S5). For example, the two-point exchange algorithm is carried out. However, other local search methods (e.g. 2-opt (k-opt) method, or-opt method, k-point exchange method, genetic method, Simulated Annealing method, Tabu search method or the like) may be used. When the priority condition is stored in the constraint data storage unit 1600, it is required that the priority condition is satisfied, also in this processing. In this embodiment, as illustrated in FIG. 7, because all operations to be conducted while traveling are arranged, it is possible to adopt any algorithms of the conventional local search methods without confirming whether or not the constraint conditions such as the priority condition, rendezvous condition and the like are satisfied among the operator groups. For example, it is assumed that the scheduled execution order after the change, which is illustrated in FIG. 11, is obtained. The orders of the operations 6 and 9 in the scheduled execution order of the operator group B are exchanged.

After that, the controller 1400 causes the traveling processing unit 1200 to execute the processing at the step S3 for the scheduled execution order after the change, which is stored in the storage unit 1500 (step S7). Namely, by determining, according to the scheduled execution order after the change, whether or not the movement to each operation place and start of the operation satisfy the constraint conditions including the priority condition and the like, which are stored in the constraint data storage unit 1600, while advancing the time, the operations to be conducted are determined in the scheduled execution order after the change for each operator group, and data of the operations to be conducted with the execution order is stored in the storage unit 1500, for each operator group. Furthermore, the evaluation value for the determined allotment of the operations is stored in the storage unit 1500.

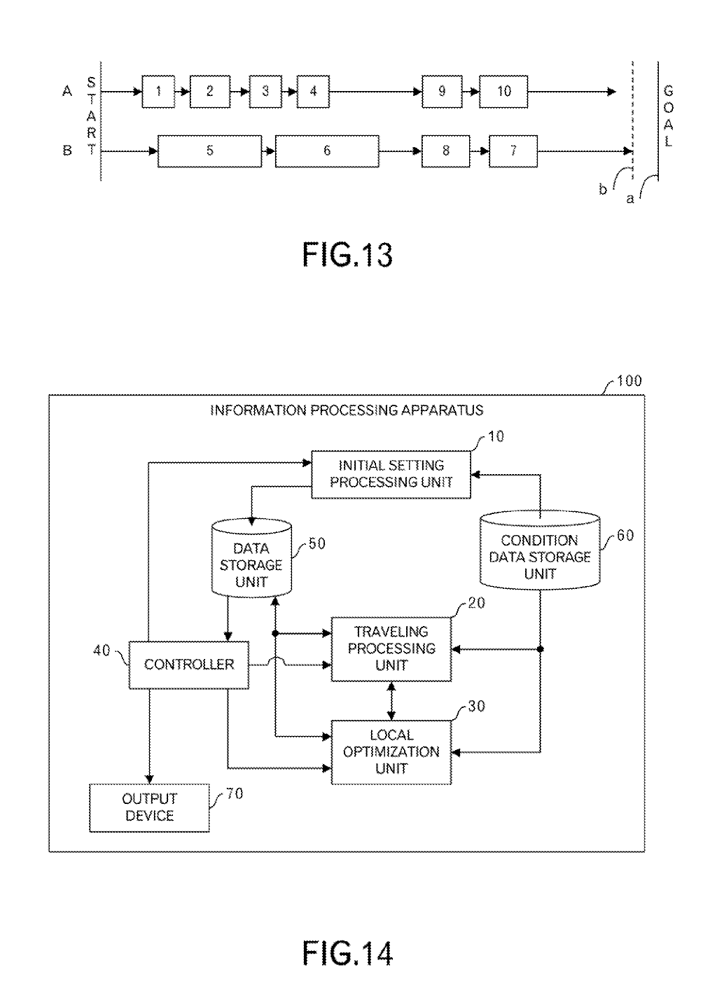

In this case, as illustrated in FIG. 12, although the scheduled execution order of the operator group A is not changed, the operations to be conducted are changed to the operations 1, 2, 3, 4, 9 and 10. In addition, as for the operator group B, it is determined according to the changed scheduled execution order, that the operations to be conducted are changed to the operations 5, 6, 8 and 7. The execution state is as schematically illustrated in FIG. 13. In this example, when a solid line “a” representing the sum of the operation time and the movement time in FIG. 8H is compared with a dotted line “b” representing the sum of the operation time and the movement time in this example, the effect of the local search method appears and it is possible to understand that the evaluation value corresponding to the sum of the operation time and the movement time of the operator group that finally returns to the goal point becomes shorter.

After that, the controller 1400 compares a reference evaluation value (initially, the evaluation value calculated at the step S3. In the subsequent processing, the evaluation value adopted and stored in an area for the next processing.) with the evaluation value calculated at the step S7 and stored in the storage unit 1500 to adopt the lesser one (step S9). In a case as illustrated in FIG. 13, because the evaluation value calculated at the step S7 is lesser, data of the operation allotment and evaluation value, which are determined at the step S7, is stored in the area for the next processing in the storage unit 1500. The data, which is not adopted, may be discarded. However, the data may be held in order to refer to the data later.

After that, the controller 1400 determines whether or the processing is to be ended (step S11). For example, it is determined whether or not a case where the evaluation value becomes less than a predetermined threshold, a case where the number of execution times of the step S7 or entire execution time exceeds the threshold, or a case where a decrease degree of the evaluation value becomes less than a predetermined value when the history data of the evaluation values are held happens. When the processing is to be ended, the controller 1400 outputs data of the operation allotment and the evaluation value, which are stored in the area for the next processing in the storage unit 1500 to an output device (step S15). Then, the processing ends.

On the other hand, when the processing does not ends, the controller 1400 sets, as a processing target, the scheduled execution order determined at the step S9 to be adopted, and the processing returns to the step S5. Namely, the processing for the local search method is further carried out.

Thus, by carrying out, for each operator group, a processing based on the scheduled execution order including all of the operations to be conducted while traveling, it becomes possible to apply algorithms of the normal local search methods. Furthermore, by carrying out the processing at the step S3, it becomes possible to appropriately identify the allotment of the operations for the operator groups while taking into consideration complicated constraint conditions.

Incidentally, in this embodiment, it is assumed that each operation is conducted at a corresponding operation place. Namely, the order of the operations corresponding to the order of the operation place to be traveled.

### Embodiment 2

An information processing apparatus 100 relating to a second embodiment of this technique is illustrated in FIG. 14.

The information processing apparatus 100 has an initial setting processing unit 10, traveling processing unit 20, local optimization unit 30, controller 40, data storage unit 50, condition data storage unit 60 and output device 70.

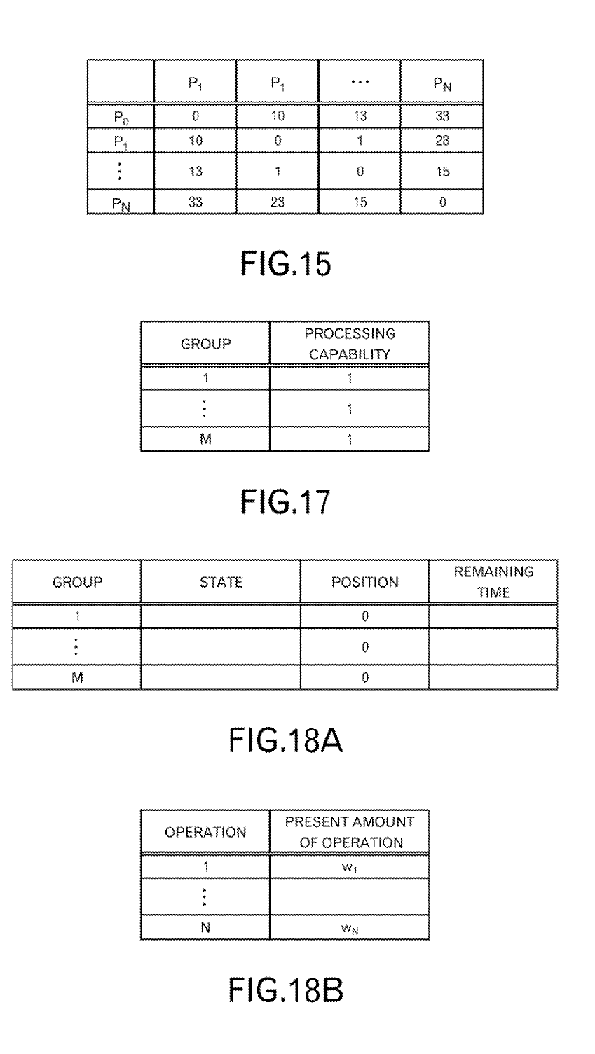

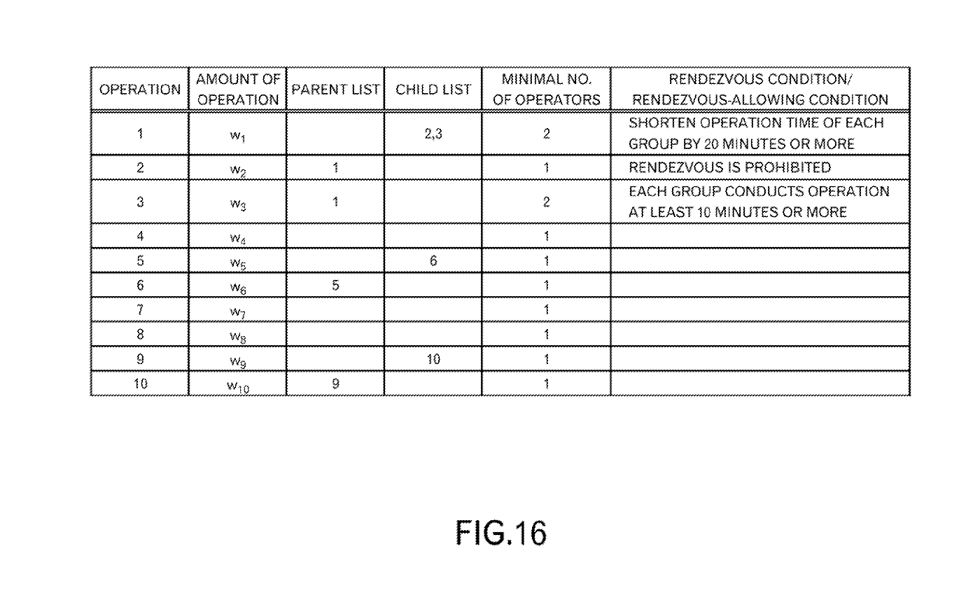

The condition data storage unit 60 stores data illustrated in FIGS. 15 to 17. For example, as illustrated in a movement cost table in FIG. 15, data of the movement time as the movement cost between two points of the start point P₀ and the operation points P₁ to P_{N} is stored. In addition, the movement starts from the start point P₀, and when all of the operations are completed, the operator groups return to the start point P₀. In addition, as illustrated, for example, in the constraint condition table in FIG. 16, an amount of operation, parent list, child list, the minimal (i.e. local minimum) number of operators, rendezvous condition and rendezvous-allowing condition are stored. FIG. 16 illustrates an example in case where the number of operations is 10. However, typically, for N operations, the aforementioned data is prepared. In addition, the priority condition is defined by the parent list and child list, and when the priority condition as illustrated in FIG. 2 is represented, the child list and parent list are set as illustrated in FIG. 16. Moreover, when the minimal (i.e. local minimum) number of operators is “1”, the operation can be conducted without the rendezvous, and the operation is conducted by one group when the rendezvous is prohibited. In addition, the required rendezvous condition and rendezvous-allowing condition are also set. Furthermore, as illustrated in the processing capability table in FIG. 17, the processing capability of the operation per unit time is also stored for each group. The operation time is calculated by dividing the amount of operation by the processing capability.

The data storage unit 50 stores data generated during the processing and data of the processing results. For example, as illustrated in a group management table in FIG. 18A, a state, present position and remaining time are stored. The states include an initial state, moving state, operating state, waiting state and complete state. The initial state represents a state before starting the operation, the moving state represents moving from a certain operation point to another operation point, the operating state represents a state that the operator group arrived at a certain point and is conducting the operation, the waiting state represents a state that the operation cannot be started due to the constraint conditions such as priority condition and the rendezvous condition, although the operator group arrived at the operation point, and the complete state represents a state that the operation is completed, and the operator group returns to the start point. The position represents the destination when the state is the moving state, and represents the position where the group currently exists in other cases. The remaining time represents a time required for the completion of the moving or the operation. However, when the state is the complete state, the remaining time indicates the total sum of the operation time and the movement time for that group. In addition, as illustrated in present operation amount management table in FIG. 18B, data storage unit 50 stores data concerning the present amount of operation. Namely, the amount of operation included in the constraint condition table illustrated in FIG. 16 is set as the present amount of operation initially. However, when the operation advances, the present amount of operation is decreased.

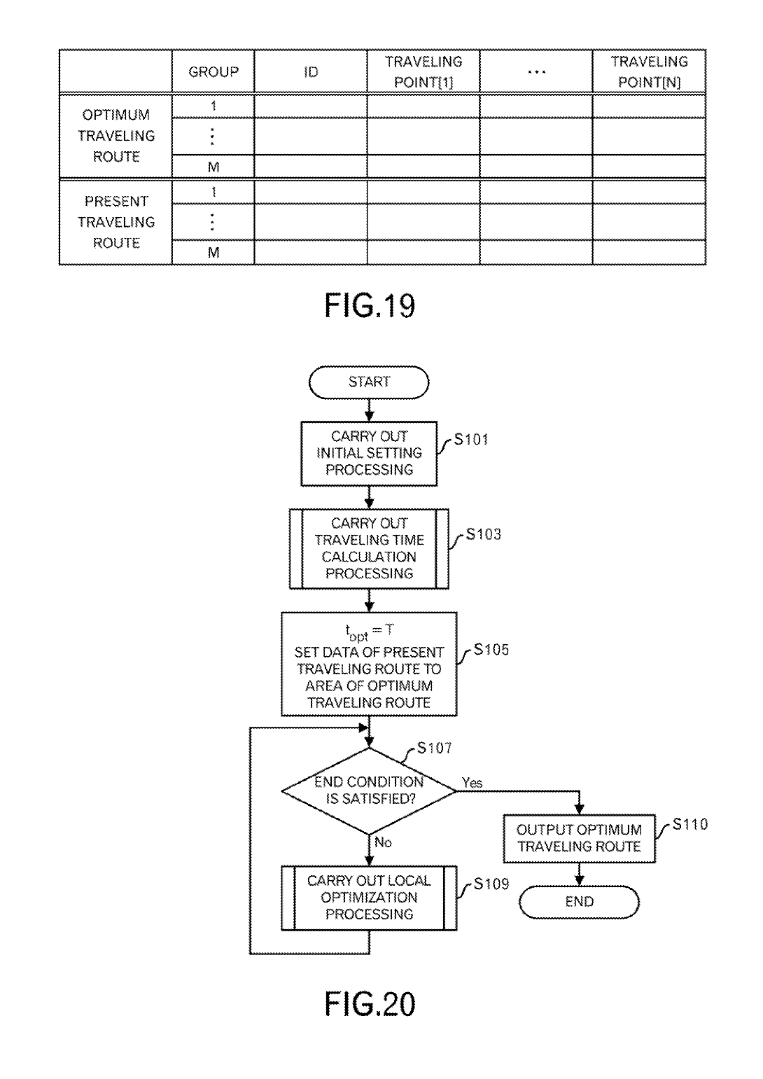

Furthermore, data as illustrated in a traveling route management table in FIG. 19 is also stored in the data storage unit 50. In an example of FIG. 19, data for the optimum traveling route among the past traveling routes and data concerning the present traveling route are also stored. For each of the optimum traveling route and present traveling route, an identifier (ID) representing the present index in the following array and array of the points (e.g. 1 to N) to be traveled are stored for each group.

The controller 40 controls to cause the initial setting processing unit 10, traveling processing unit 20 and local optimization unit 30 to carry out the following processing.

The initial setting processing unit 10 generates, for each group, a scheduled traveling route by arranging all operation places to be traveled so as to satisfy the priority condition when the priority condition is set in the constraint condition table of the condition data storage unit 60, and stores data of the scheduled traveling route into the data storage unit 50.

The traveling processing unit 20 determines, for each group, whether or not the movement to the operation place of each operation relating to the scheduled traveling route and the start of the operation satisfy the constraint conditions stored in the condition data storage unit 60, while advancing the time, and determines the operation points in the scheduled traveling route for each group, and registers data concerning the determined operation places into the traveling route management table stored in the data storage unit 50. In addition, the traveling processing unit 20 updates the time (i.e. value of the remaining time in the group management table) as the evaluation value for the determined traveling order, into group management table in the data storage unit 50. Incidentally, the traveling processing unit 20 calculates the time required for each operation and the time required for moving between the operation points, when advancing the time, by using data stored in the condition data storage unit 60.

The local optimization unit 30 changes the scheduled traveling route stored in the data storage unit 50 so as to satisfy the priority condition in case where the priority condition is registered in the constrain condition table in the condition data storage unit 60, and stores data of the scheduled traveling route after the change into the data storage unit 50. The processing of the local optimization unit 30 is carried out according to the algorithm of the conventional local search method.

The controller 40 causes the traveling processing unit 20 to carry out a processing for the scheduled traveling route after the change, and to calculate the evaluation value (i.e. time) for the scheduled traveling route after the change. Then, the controller 40 determines whether or not the evaluation value for the scheduled traveling route after the change becomes less than the evaluation values that are previously calculated, and stores the evaluation value, data of the traveling order (or execution order of the operations) and the scheduled traveling route after the change as data for the next processing, into the data storage unit 50 when the evaluation value is lowered. When the evaluation value for the scheduled traveling route after the change is not lowered, the controller 40 discards the scheduled traveling route after the change and associated data. Then, the controller 40 causes the local optimization unit 30 and traveling processing unit 20 to carry out the processing until the end condition is satisfied.

Next, processing contents of the information processing apparatus 100 illustrated in FIG. 14 will be explained by using FIGS. 20 to 33B. First, the controller 40 causes the initial setting processing unit 10 to carry out an initial setting processing (FIG. 20: step S101). The initial setting processing includes a processing to generate an initial scheduled traveling route.

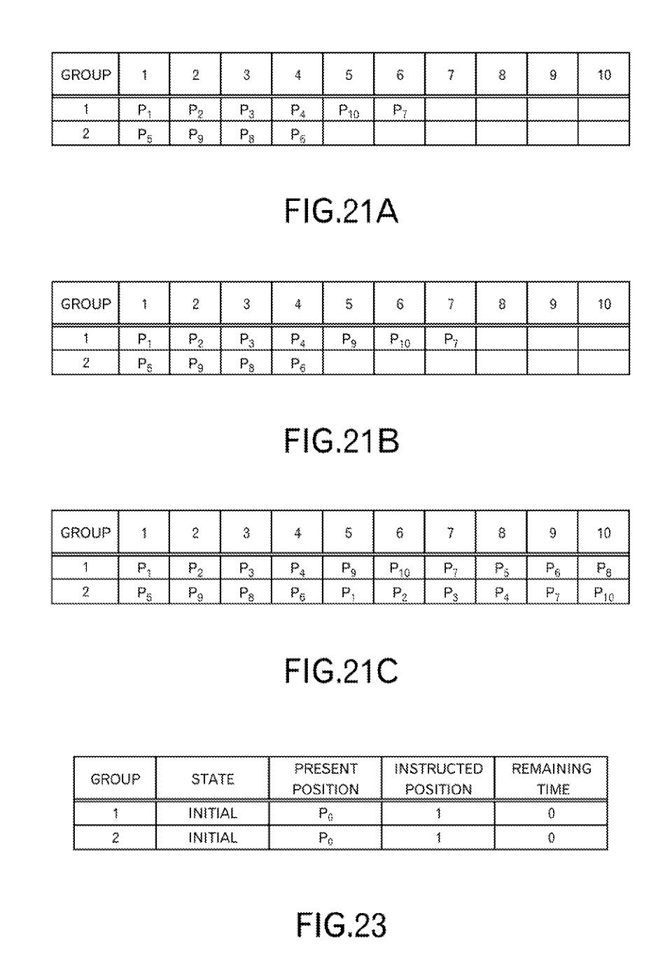

The processing to generate the initial scheduled traveling route is carried out, for example, according to one of two methods. In the first method, for example, for each group, the operations to be conducted while traveling are randomly arranged, and the initial scheduled traveling route is generated by arranging the corresponding operation points according to the arranged operations. Then, when the priority condition is set in the constraint condition table in the condition data storage unit 60, a processing to exchange the order so as to satisfy the priority condition is carried out for each group, for example. The second method is a method for generating, for each group, the scheduled traveling route by using, as an initial value, a traveling route (i.e. solution) generated by other methods. For example, when a solution as illustrated in FIG. 21A is obtained, it is checked, for each group, whether or not there is a portion in which the priority condition is not satisfied, and when there is a portion in which the priority condition is not satisfied, a parent point is inserted immediately before. In case of FIG. 21A, as for the group 1, because the parent point before the point P₁₀ does not exist, the parent point P₉ is inserted immediately before the point P₁₀ as illustrated in FIG. 21B. The remaining operation points are randomly set so as to satisfy the priority condition. As illustrated in FIG. 21C, as for 8-th to 10-th operation places, the remaining operation points are inserted so as to satisfy the priority condition. More specifically, because the operation point P₅ is the parent point and the operation point P₆ is a child point, this arrangement is maintained. On the other hand, as for the group 2, because there is no operation place to which the priority condition relates among the remaining operation points, the operation points are randomly added. Incidentally, although the scheduled traveling route is generated by arranging the operation points in the example illustrated in FIG. 21A to 21C, the scheduled operation order may be generated by arranging the operations according to the similar method. The scheduled traveling route may be generated from this scheduled operation order. Namely, in this embodiment, the operation place (i.e. operation point) corresponds to the operation one-by-one.

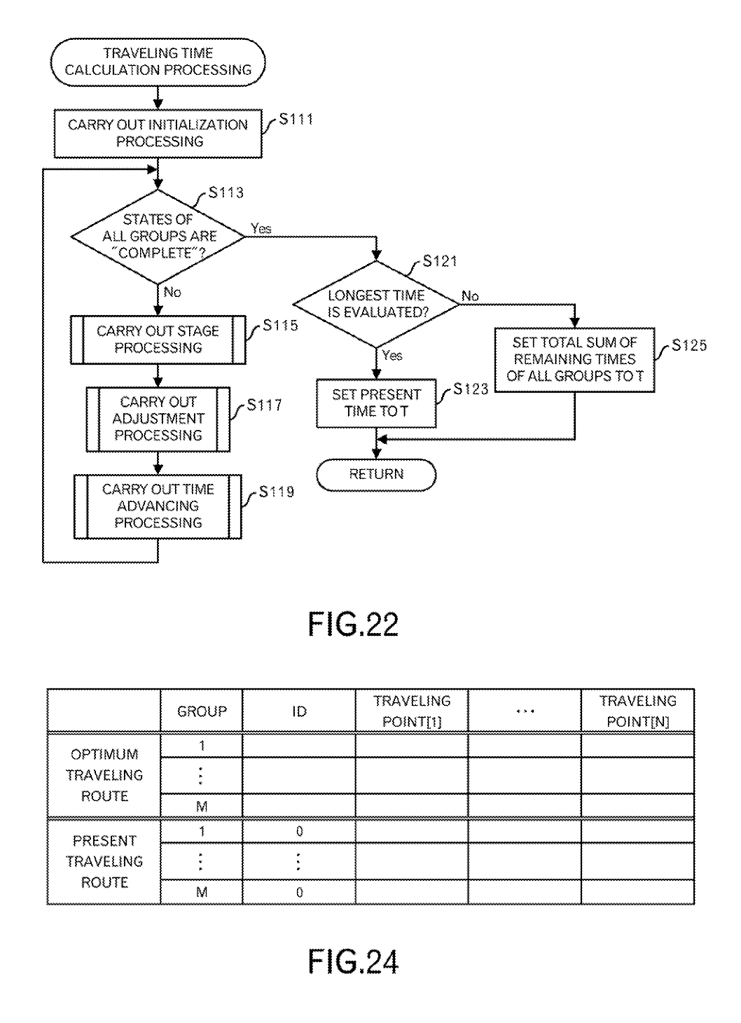

Next, the controller 40 causes the traveling processing unit 20 to carry out a traveling time calculation processing (step S103). The traveling time calculation processing will be explained by using FIGS. 22 to 25.

First, the traveling processing unit 20 initializes the group management table and the traveling route management table, and sets “0” to the present time (FIG. 22: step S111). As illustrated in FIG. 23, as for the group management table, “initial” is set as the state, the start point P₀ is set as the present position, “1” is set as an instructed position, and “0” is set as the remaining time. As for the traveling route management table, as illustrated in FIG. 24, “0” is set as an ID of each group for the present traveling route. Incidentally, data concerning the amount of operation in the constraint condition table is copied and stored into the present operation amount management table.

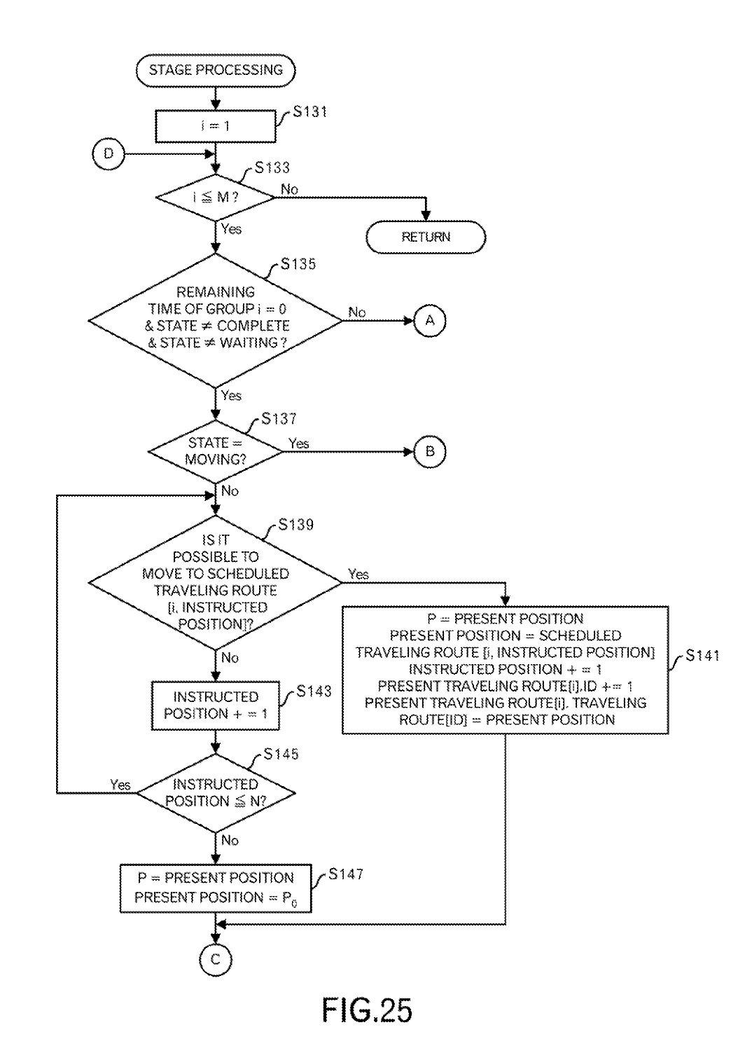

After that, the traveling processing unit 20 determines whether or not “complete” has been set as the states of all groups in the group management table (step S113). When there is a group whose state is not “complete”, the traveling processing unit 20 carries out a stage processing (step S115). The stage processing will be explained by using FIGS. 25 to 27. Incidentally, the stage represents the minimal (i.e. local minimum) time until a next event occurs. Specifically, this is the time until the movement of a certain group is completed or until the operation is completed.

In this stage processing, the traveling processing unit 20 initializes i, which is a counter of a group, to “1” (FIG. 25: step S131), and determines whether or not i is equal to or less than the maximum number M of groups (step S133). When i exceeds M, a processing returns to a calling-source processing.

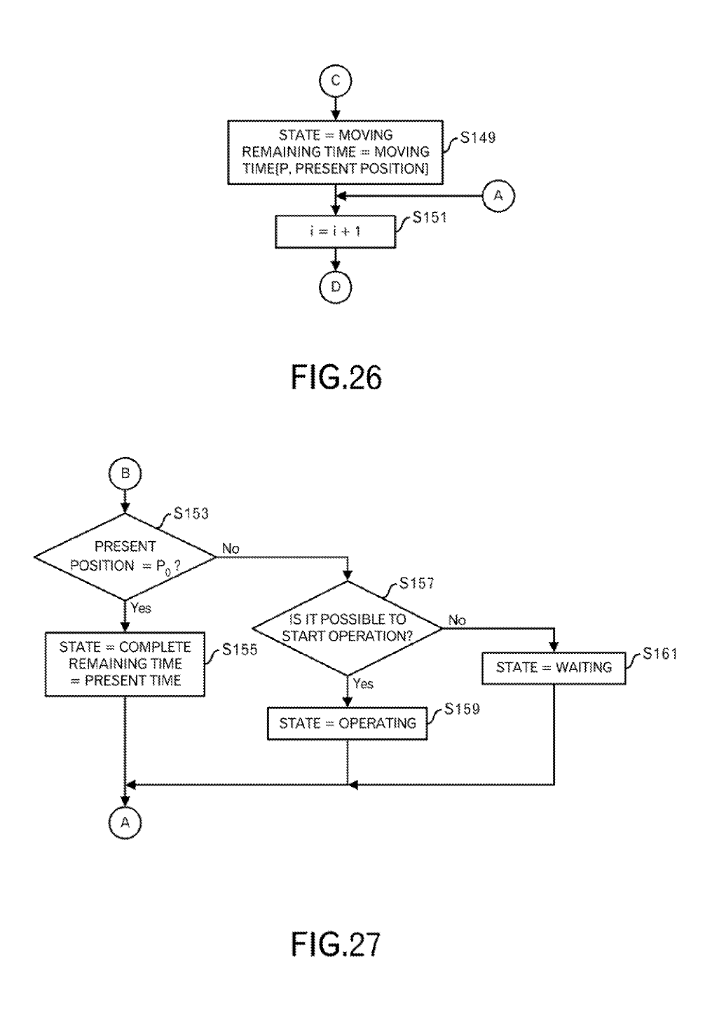

On the other hand, when i is equal to or less than M, the traveling processing unit 20 determines, based on data of the group management table, whether or not the remaining time of the group i is “0” and the state is not “complete” and state is not “waiting” (step S135). The remaining time of the group i being “0” means a state in which the movement or operation is completed, the state not being “complete” means that the group i does not return to the start point, and the state not being “waiting” means that the state is not a state in which the group i waits for the completion of the operation by the other groups. When such conditions are not satisfied, the processing shifts to a processing of FIG. 26 through a terminal A.

On the other hand, when such conditions are satisfied, the traveling processing unit 20 determines whether or not the state of the group i is “moving” (step S137). When the state is “moving”, the processing shifts to a processing of FIG. 27 through a terminal B. On the other hand when the state is not “moving”, the state is “operating”, and it means that a certain operation conducted by the group i is completed. Then, the traveling processing unit 20 determines according to the constraint conditions defined in the constraint condition table, whether or not it is possible to move to an operation point of the scheduled traveling route [i, instructed position] (step S139). Whether or not it is possible to move to the operation point of the scheduled traveling route [i, instructed position] is determined, firstly, based on whether or not the rendezvous condition or rendezvous-allowing condition is satisfied.

For example, when there is a group that previously moves to that position, the group has a priority, and when the rendezvous-allowing condition is set, it is determined whether or not the rendezvous-allowing condition is satisfied. If the rendezvous condition that the rendezvous is not allowed is set, the group that firstly started moving moves to that position, and it is determined that the other groups “cannot move”. When another group has completed that operation, it is determined that the other groups “cannot move”. In addition, a waiting option concerning whether or not the waiting for the completion of the operation conducted by the other groups because of the priority constraint or the like is allowed may be set. In such a case, when the rendezvous condition is satisfied and a setting has been made that the waiting is allowed for even an operation, which cannot be conducted immediately, it is determined that it is possible to move to that operation point.

When it is determined that it is impossible to move, the traveling processing unit 20 increments the number corresponding to the instructed position of the group i in the group management table by “1” (step S143), and also determines whether or not the number corresponding to the instructed position is equal to or less than the number N of operations (step S145). When the number corresponding to the instructed position is equal to or less than the number N of operations, the processing returns to the step S139. On the other hand, when the number corresponding to the instructed position exceeds the number N of operations, the traveling processing unit 20 sets the present position in the group management table to a variable P, and sets the start point P₀ to this present position (step S147). Namely, the operator group returns to the start point P₀ without further conducting operations. Then, the processing shifts to a processing of FIG. 26 through a terminal C.

On the other hand, when it is determined at the step 5139 that it is possible to move to the scheduled traveling route [i, instructed position], the traveling processing unit 20 sets the present position to the variable P, sets the scheduled traveling route [i, instructed position] to the present position, increments the number corresponding to the instructed position by “1”, increments the present traveling route [i].ID (i.e. ID of the group i in a line of the present traveling route) by “1”, and sets the present position to the present traveling circuit [i].traveling route [ID] (i.e. a column of the traveling route [ID] of the group i in the line of the present traveling route) (step S141). Namely, the next movement destination is stored into the traveling route [ID]. After that, the processing shifts to the processing of FIG. 26 through the terminal C.

The processing after the terminal C is explained by using FIG. 26. The traveling processing unit 20 changes the state in the group management table to “moving”, and sets the movement time between the variable P in the movement cost table and the present position to the remaining time in the group management table (step S149). Then, the traveling processing unit 20 increments i by “1” (step S151). After that, the processing returns to the step 5133 of FIG. 25 through a terminal D.

On the other hand, the processing after the terminal B is explained by using FIG. 27. The traveling processing unit 20 determines whether or not the present position in the group management table is the start point P₀ (step S153). When the present position is P₀, the traveling processing unit 20 sets “complete” to the state in the group management table, and sets the present time to the remaining time (step S155). Then, the processing shifts to the step S151 of FIG. 26 through the terminal A. On the other hand, when the present position is not the start point P₀, the traveling processing unit 20 determines whether or not it is possible to start the operation at the present position (step S157). Whether or not it is possible to start the operation is determined based on whether or not all of the parent operations are completed when the priority condition is set. Furthermore, it is determined whether or not the number of operators whose state is “waiting” or “operating” at the present position which include its own operators in this group is equal to or greater than the minimal (i.e. local minimum) number of operators. When such conditions are satisfied, it is determined that it is possible to start the operation. When it is possible to start the operation, the traveling processing unit 20 changes the state of the group i to “operating” in the group management table (step S159). Then, the processing shifts to the step S151 of FIG. 26 through the terminal A. On the other hand, when it is determined that it is impossible to start the operation, the traveling processing unit 20 sets the state of the group i to “waiting” in the group management table (step S161). Then, the processing shifts to the step S151 of FIG. 26 through the terminal A.

Thus, it is possible to determine, for each group, whether or not it is possible to start moving or start operating.

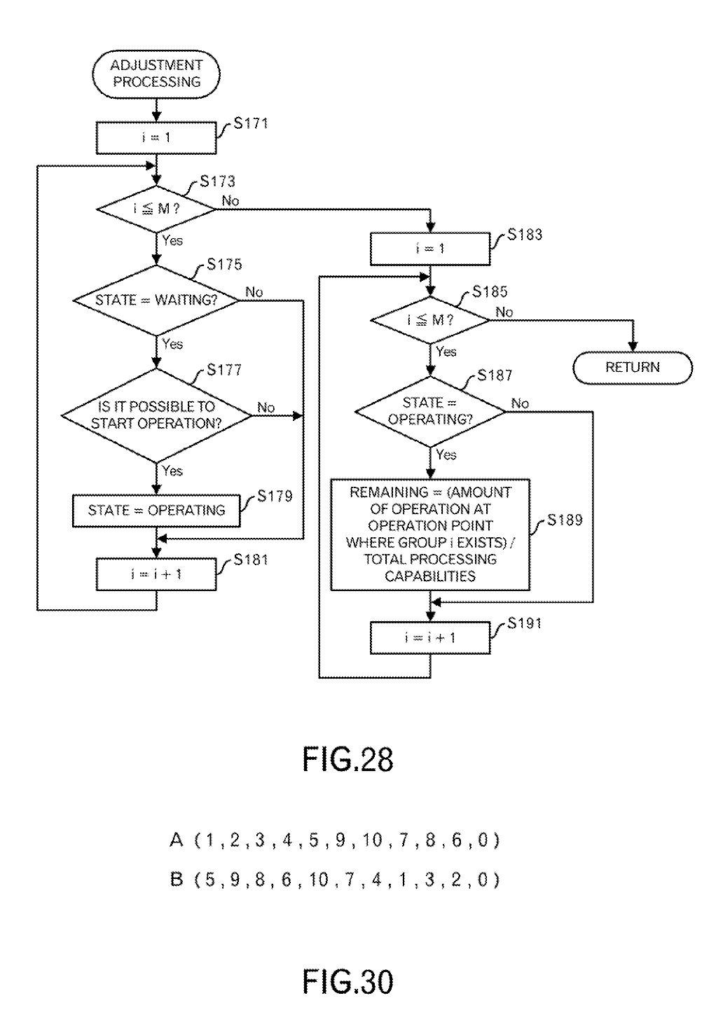

Returning to the explanation of the processing in FIG. 22, the traveling processing unit 20 carries out an adjustment processing next (step S117). The adjustment processing is explained by using FIG. 28. The state change is simultaneously carried out in actual. However, in the processing flow, the state change is sequentially carried out from the group 1. Therefore, there is possibility that a time gap is caused in the state change. For example, when two groups simultaneously arrived at an operation point whose minimal (i.e. local minimum) number of operators is “2”, it is possible to start the operation. However, in the aforementioned processing, because it is impossible to check the simultaneous arrival, the state remains in “waiting”. Then, by carrying out the following processing, the traveling processing unit 20 makes the operation start.

Firstly, the traveling processing unit 20 initializes a counter i of the group to “1” (step S171). Then, the traveling processing unit 20 determines whether or not i is equal to or less than the maximum number M of groups (step S173). When i is equal to or less than M, the traveling processing unit 20 determines whether or not the state of the group i is “waiting” in the group management table (step S175). When the state is not “waiting”, the processing shifts to step S181. On the other hand, when the state is “waiting”, the traveling processing unit 20 determines whether or not it is possible to start the operation at the present position (step S177). This determination is the same as that at the step S157. When it is impossible to start the operation at the present position, the processing shifts to the step S181.

On the other hand, when it is possible to start the operation at the present position, the traveling processing unit 20 changes the state of the group i to “operating” (step S179), and increments i by “1” (step S181). After that, the processing returns to the step S173.

On the other hand, when it is determined at the step S173 that i exceeds M, the traveling processing unit 20 initializes i to “1” (step S183), and determines whether or not i is equal to or less than the maximum number M of groups (step S185). When i exceeds M, the processing returns to the calling-source processing.

On the other hand, when i is equal to or less than M, the traveling processing unit 20 determines whether or not the state of the group i is “operating” in the group management table (step S187). When the state is not “operating”, the processing shifts to step S191. On the other hand, when the state is “operating”, the traveling processing unit 20 sets (an amount of operation at the operation point of the group i)/total processing capabilities (i.e. total sum of the processing capabilities of the groups operating at the operation point of the group i) to the remaining time (step S189). After that, the traveling processing unit 20 increments i by “1” (step S191). Then, the processing returns to the step S185.

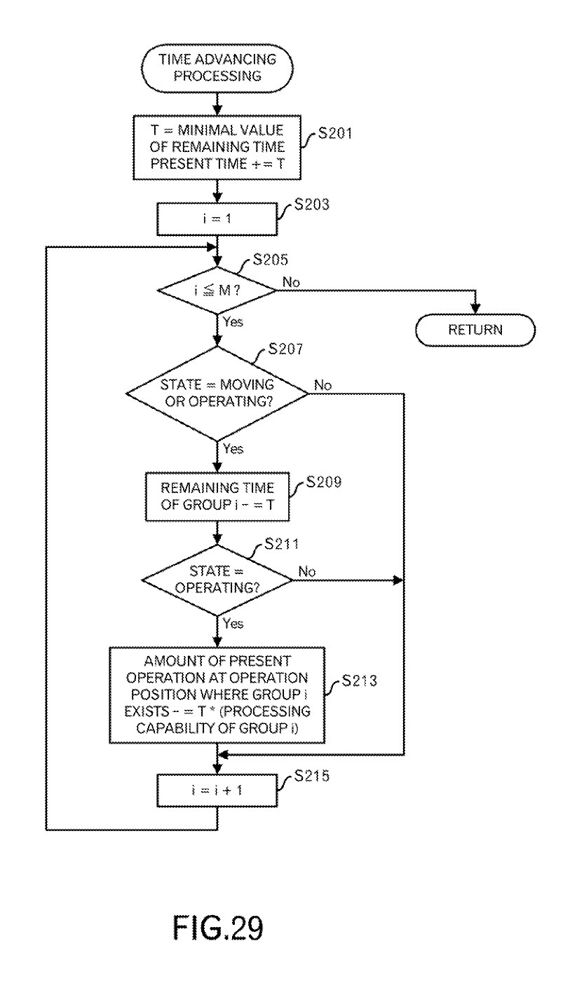

Returning to the explanation of the processing in FIG. 22, the traveling processing unit 20 carries out a time advancing processing (step S119). The time advancing processing is explained by using FIG. 29.

Firstly, the traveling processing unit 20 extracts the minimal (i.e. local minimum) value of the remaining time in the group management table to set it to T, and adds T to the present time to advance the time (FIG. 29: step S201). In addition, the traveling processing unit 20 initializes the counter i of the group to “1” (step S203). Furthermore, the traveling processing unit 20 determines whether or not i is equal to or less than the number M of groups (step S205). When i exceeds M, the processing returns to the calling-source processing. On the other hand, when i is equal to or less than M, the traveling processing unit 20 determines whether or not the state of the group i is “moving” or “operating” in the group management table (step S207). When the state is not “moving” or “operating”, the processing shifts to the step s215. On the other hand, when the state is “moving” or “operation”, the traveling processing unit 20 decreases the remaining time of the group i by “T” (step S209). Furthermore, the traveling processing unit 20 determines whether or not the state of the group i is “operating” (step S211). When the state is not “operating”, the processing returns to the step S215.

On the other hand, when the state is “operating”, the traveling processing unit 20 reduces the amount of operation at the operation point where the group i exists by “T*(processing capability of the group i)” (step S213). Then, the traveling processing unit 20 increments i by “1” (step S215). After that, the processing returns to the step S205.

Thus, the time advances step-by-step, and the state of each group is shifted, and the movement destination is determined according to the constraint conditions.

Returning to the explanation of the processing in FIG. 22, when it is determined at the step S113 that the states of all groups are “complete”, the traveling processing unit 20 determines whether or not the evaluation of the present traveling route is made by the maximum value of the values of all groups, which are calculated by adding the movement time and the operation time (step S121). When the evaluation of the present traveling route is made by the maximum value of the values of all groups, which are calculated by adding the movement time and the operation time, the traveling processing unit 20 sets the present time to the variable T for the evaluation value (step S123). Then, the processing returns to the calling-source processing. The variable T is stored in the data storage unit 50.

On the other hand, when the evaluation of the present traveling route is not made by the maximum value of the values of all groups, which are calculated by adding the movement time and the operation time, the traveling processing unit 20 sets the total sum of the remaining times of all groups to the variable T (step S125). Because the present time at the completion is set to the remaining time, the total sum of the movement times and the operation times of all groups are calculated. Then, the processing returns to the calling-source processing. Thus, the evaluation value of the present traveling route is obtained.

Incidentally, when the total sum of the movement times and the operation times of all groups is calculated as the evaluation value, “0” is added, which represents that the group returns to the start point without moving the next operation point, to the scheduled traveling route. For example, as illustrated in FIG. 30, initially, “0” is added to the last position. However, “0” may be arranged at any position without considering the other constraint conditions. Incidentally, the processing itself is basically similar to the aforementioned processing. However, when the traveling of the entire operation places is not completed due to the influence of introducing “0” and all groups ends the operations, the evaluation becomes infinite. Or, the group, which finally selects “0”, carries out the remaining operations by ignoring “0”, and the evaluation value is calculated according to the aforementioned method.

Returning to the explanation of the processing in FIG. 20, the controller 40 sets the value of the variable T to tₒₚₜ, and further sets data of the present traveling route to an area of the optimum traveling route in the traveling route management table (step S105). Initially, the present traveling route generated at the step S103 is set as the optimum traveling route.

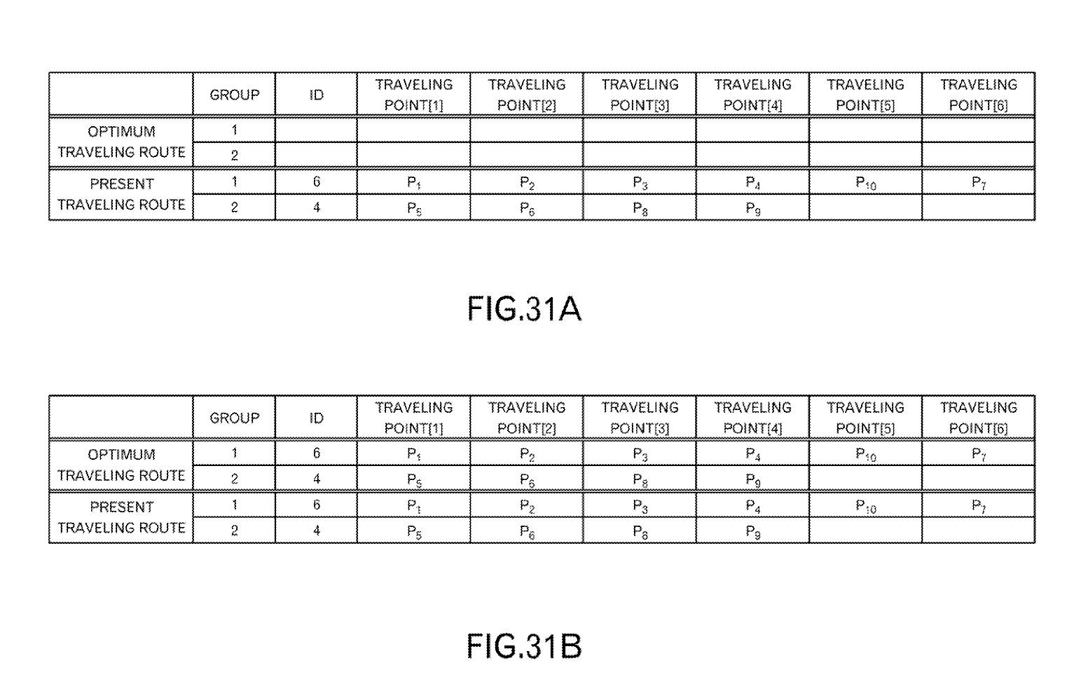

For example, when the aforementioned processing is carried out, data as illustrated in FIG. 31A is stored in the traveling route management table. Namely, data is set in the line of the present traveling route. At this step, data of the present traveling route is copied to the line of the optimum traveling route. Therefore, the state as illustrated in FIG. 31B is obtained.

After that, the controller 40 determines whether or not the end condition is satisfied (step S107). For example, when the time since the processing begins elapsed a predetermined time, or when tₒₚₜ is less than a predetermined threshold, or when tₒₚₜ is not reduced a predetermined value or more in a predetermined time or the predetermined number of repetition times, it is determined that the end condition is satisfied. When the end condition is satisfied, the controller 40 outputs data in the area of the optimum traveling route in the traveling route management table stored in the data storage unit 50 to the output device 70 (step S110). Then, the processing ends. The evaluation value tₒₚₜ may be outputted.

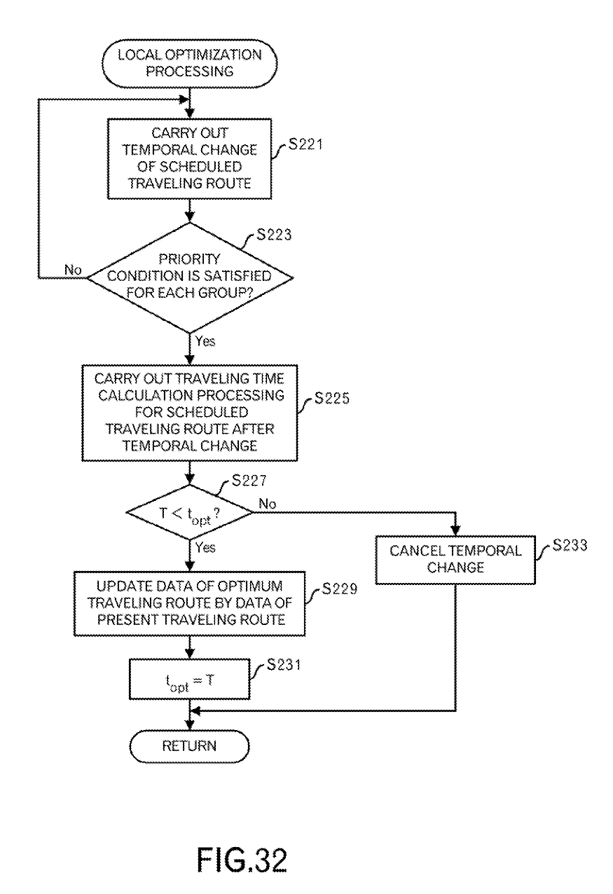

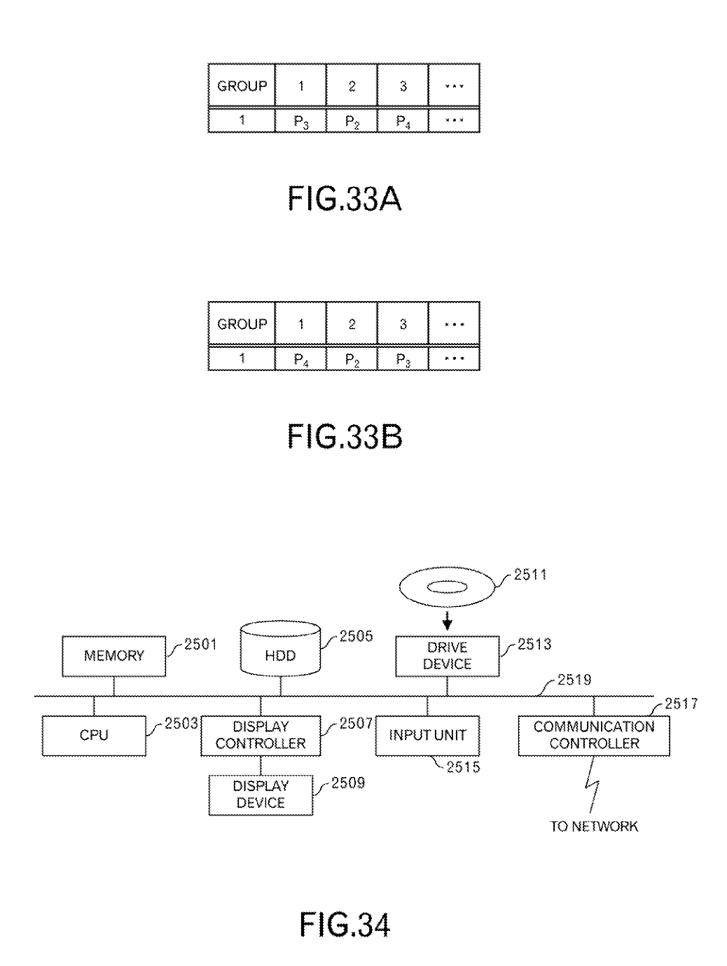

On the other hand, when the end condition is not satisfied, the controller 40 causes the local optimization unit 30 and the like to carry out the local optimization processing (step S109). When the step S109 is completed, the processing returns to the step S107. The conventional local optimization processing itself may be adopted, as described above. Here, the two-point exchange algorithm will be explained by using FIGS. 32 to 33B.

Firstly, the local optimization unit 30 carries out a temporal change of the scheduled traveling route stored in the data storage unit 50, and stores the scheduled traveling route after the change into the data storage unit 50 (FIG. 32: step S221). In case of the two-point exchange algorithm, one of the group numbers is randomly selected to set it to a variable g. Furthermore, a combination (i, j) of indexes, which has not been selected, is selected. Then, the i-th operation point of the group g is exchanged with the j-th operation point of the group g in the scheduled traveling route. Specifically, when the scheduled traveling route (a portion of the scheduled traveling route) exists as illustrated in FIG. 33A and g=1, i=1 and j=3 are set, the first operation point is exchanged with the third operation point as illustrated in FIG. 33B.

Then, the local optimization unit 30 determines, for each group, whether or not the priority condition defined in the constraint condition table is satisfied (step S223). When the priority condition is not satisfied, the processing returns to the step S221 to change the scheduled traveling route. On the other hand, when the priority condition is satisfied, the local optimization unit 30 requests the traveling processing unit 20 to carry out the traveling time calculation processing for the scheduled traveling route after the temporal change (step S225). Then, the traveling processing unit 20 carries out the aforementioned traveling time calculation processing.

When the processing at the step S225 is completed and the processing result is stored in the data storage unit 50, the controller 40 determines whether or not T calculated at the step S225 is less than tₒₚₜ (step S227). When T is equal to or greater than tₒₚₜ, the controller 40 discards the scheduled traveling route after the temporal change, which was carried out at the step S221 (step S233). Then, the processing returns to the calling-source processing.

On the other hand, when T is less than tₒₚₜ, the controller 40 updates data of the optimum traveling route with data of the present traveling route in the traveling route management table (step S229). This is similar to the processing at the step S5. Furthermore, the controller 40 sets the value of T to tₒₚₜ (step S231). Then, the processing returns to the calling-source processing.

By carrying out the aforementioned processing, namely, carrying out the local search, the traveling routes (i.e. operation allotment) whose tₒₚₜ is lesser are obtained.

Incidentally, there are various algorithms of the local search methods, and by adopting the configuration of this embodiment, it is possible to adopt even the algorithm of the local search method that cannot handle the traveling salesman problem in which plural groups conduct operations.

Furthermore, even when various constraint conditions are set, it is possible to absorb them by determining whether or not it is possible to start moving or start the operation in the traveling time calculation processing. Moreover, it is possible to cope with the movement costs that vary according to time by switching the movement cost tables. Furthermore, it is possible to take into consideration the break time.

Incidentally, the local optimization may be repeated for a lot of initial scheduled traveling routes instead of repetition of the local optimization for one initial scheduled traveling route.

Although the embodiments of this technique are described above, this technique is not limited to these embodiments. For example, the functional block diagrams are mere examples, and do not correspond to an actual program module configuration. Furthermore, as for the processing flows, as long as the processing results do not change, the order of the steps may be exchanged, and the steps may be executed in parallel. The functional allotment may be made by plural computers.

In addition, in the aforementioned examples, it is assumed that the start point is the same as the end point. However, it is a mere example, and they may be different points. Furthermore, the start point may not be fixed.

In addition, the aforementioned information processing apparatuses 100 and 1000 are computer device as shown in FIG. 34. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 34. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiment is summarized as follows:

An information processing method relating to the embodiments includes: (A) first determining, for each of a plurality of operator groups, scheduled execution order by arranging, for each of the plurality of operator groups, the predetermined number of operations to be conducted while traveling, wherein at least a portion of the predetermined number of operations is allotted to each of the plurality of operator groups; (B) second determining, for each of the plurality of operator groups, operations to be conducted in the scheduled execution order by determining, for each of the plurality of operator groups, along the scheduled execution order of the operator group and while advancing time, whether movement to an operation place of each operation of the predetermined number of operations and start of the operation satisfy a constraint condition set in advance for the predetermined number of operations; and (C) calculating a first evaluation value of orders of the operations determined to be conducted for the plurality of operator groups.

When the operation order is firstly determined for each of the plurality of operator groups, there is a case where algorithms of the typical local search methods cannot be applied due to the constraint conditions. However, when the scheduled execution order of the operations to be conducted is determined as described above for each operator group, the algorithms of the typical local search methods can be applied, because there is no need to carry out a processing to satisfy the constraint condition for the inter-operator groups. Furthermore, because the final execution order of the operations is determined while advancing the time after considering the constraint conditions, it is possible to handle complicated constraint conditions. In addition, when the operation corresponds to the operation place one-by-one, the aforementioned processing is substantially the same as a processing for the traveling order of the operation places. Moreover, the operation that another group has been finished is skipped without conducting it in the scheduled execution order.

This information processing method may further include: (D) changing a portion of the scheduled execution order based on a predetermined rule; carrying out the second determining and the calculating for the scheduled execution order after the changing; and (E) upon determining that a second evaluation value calculated in the carrying out for the scheduled execution order after the changing is less than the first evaluation value, storing the second evaluation value, orders of operations determined to be conducted for the plurality of operator groups, and the scheduled execution order after the change. Various rules may be adopted for the predetermined rule in the changing, and it may be a rule in which the constraint conditions cannot be satisfied among the operator groups.

Furthermore, in this information processing method, the changing, the carrying out and the storing may be repeated until a first condition that the second evaluation value becomes less than a first threshold, a second condition that an execution time consumed from the first determining to the storing exceeds a predetermined first period or a third condition that a state that a variation of the second evaluation value is less than a second threshold is kept for a predetermined second period is satisfied. Thus, it becomes possible to obtain much preferable execution order of the operations for each operator group.

Incidentally, the aforementioned second determining may include: storing, for each of the plurality of operator groups, an operation state and a movement destination or operation place while advancing time; and storing, for each of the plurality of operator groups, identifiers of the operations determined to be conducted among the predetermined number of operations or operation places of the operations determined to be conducted, in sequence.

Furthermore, the first determining may include determining whether or not the scheduled execution order satisfies a priority condition included in the constraint conditions. In addition, the changing may include determining whether or not the scheduled execution order after the changing satisfies a priority condition included in the constraint conditions.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure comprising:
first determining, for each of a plurality of operator groups, scheduled execution order by arranging, for each of the plurality of operator groups, the predetermined number of operations to be conducted while traveling, wherein at least a portion of the predetermined number of operations is allotted to each of the plurality of operator groups;
second determining, for each of the plurality of operator groups, operations to be conducted in the scheduled execution order by determining, for each of the plurality of operator groups, along the scheduled execution order of the operator group and while advancing time, whether movement to an operation place of each operation of the predetermined number of operations and start of the operation satisfy a constraint condition set in advance for the predetermined number of operations; and
calculating a first evaluation value of orders of the operations determined to be conducted for the plurality of operator groups.

2. The computer-readable, non-transitory storage medium as set forth in claim 1, wherein the procedure further comprises:
changing a portion of the scheduled execution order based on a predetermined rule;
carrying out the second determining and the calculating for the scheduled execution order after the changing; and
upon determining that a second evaluation value calculated in the carrying out for the scheduled execution order after the changing is less than the first evaluation value, storing the second evaluation value, orders of operations determined to be conducted for the plurality of operator groups, and the scheduled execution order after the change.

3. The computer-readable, non-transitory storage medium as set forth in claim 2, wherein the changing, the carrying out and the storing are repeated until a first condition that the second evaluation value becomes less than a first threshold, a second condition that an execution time consumed from the first determining to the storing exceeds a predetermined first period or a third condition that a state that a variation of the second evaluation value is less than a second threshold is kept for a predetermined second period is satisfied.

4. The computer-readable, non-transitory storage medium as set forth in claim 1, wherein the second determining comprises:
storing, for each of the plurality of operator groups, an operation state and a movement destination or operation place while advancing time; and
storing, for each of the plurality of operator groups, identifiers of the operations determined to be conducted among the predetermined number of operations or operation places of the operations determined to be conducted, in sequence.

5. The computer-readable, non-transitory storage medium as set forth in claim 1, wherein the first determining comprises determining whether or not the scheduled execution order satisfies a priority condition included in the constraint conditions.

6. The computer-readable, non-transitory storage medium as set forth in claim 2, wherein the changing comprises determining whether or not the scheduled execution order after the changing satisfies a priority condition included in the constraint conditions.

7. An information processing method, comprising:
first determining, for each of a plurality of operator groups and by using a computer, scheduled execution order by arranging, for each of the plurality of operator groups, the predetermined number of operations to be conducted while traveling, wherein at least a portion of the predetermined number of operations is allotted to each of the plurality of operator groups;
second determining, for each of the plurality of operator groups and by using the computer, operations to be conducted in the scheduled execution order by determining, for each of the plurality of operator groups, along the scheduled execution order of the operator group and while advancing time, whether movement to an operation place of each operation of the predetermined number of operations and start of the operation satisfy a constraint condition set in advance for the predetermined number of operations; and
calculating, by using the computer, a first evaluation value of orders of the operations determined to be conducted for the plurality of operator groups.

8. An information processing apparatus, comprising:
a memory; and
a processor using the memory and configured to execute a procedure comprising:
first determining, for each of a plurality of operator groups, scheduled execution order by arranging, for each of the plurality of operator groups, the predetermined number of operations to be conducted while traveling, wherein at least a portion of the predetermined number of operations is allotted to each of the plurality of operator groups;
second determining, for each of the plurality of operator groups, operations to be conducted in the scheduled execution order by determining, for each of the plurality of operator groups, along the scheduled execution order of the operator group and while advancing time, whether movement to an operation place of each operation of the predetermined number of operations and start of the operation satisfy a constraint condition set in advance for the predetermined number of operations; and
calculating a first evaluation value of orders of the operations determined to be conducted for the plurality of operator groups.
